(19) United States
(12) Patent Application Publication
(10) Pub. No.: US 2025/0286965 A1
(43) Pub. Date: Sep. 11, 2025

(54) IMAGE PROCESSING APPARATUS CAPABLE OF OBTAINING RESULT OF PROOFREADING OF ORIGINAL WITH SIMPLE OPERATION, CONTROL METHOD, AND STORAGE MEDIUM

(71) Applicant: CANON KABUSHIKI KAISHA, Tokyo (JP)

(72) Inventor: Naoto SASAHARA, Ibaraki (JP)

(21) Appl. No.: 18/986,844

(22) Filed: Dec. 19, 2024

(30) Foreign Application Priority Data
Mar. 8, 2024 (JP) 2024-035859

(51) Int. Cl. H04N 1/00; H04N 1/32

(52) U.S. Cl. CPC H04N 1/00395; H04N 1/00233; H04N 1/00461; H04N 1/32101; H04N 2201/0094

(57) ABSTRACT

An image processing apparatus that communicably connects to a proofreading server that performs inference using a learned model. Image data read from an original is acquired. A prompt for causing the proofreading server to proofread the acquired image data is generated. The acquired image data and the generated prompt are transmitted to the proofreading server, and the proofreading server performs proofreading based on the generated prompt using the learned model with respect to the acquired image data and outputs a result of the proofreading. A proofreading result output from the proofreading server is output to an output destination.

### BACKGROUND OF THE INVENTION

### Field of the Invention

The present invention relates to an image processing apparatus that is capable of obtaining a result of proofreading of an original with a simple operation, a control method, and a storage medium, and more particularly to an image processing apparatus that performs proofreading by using an external server, a control method, and a storage medium.

### Description of the Related Art

In recent years, Artificial Intelligence (AI) represented by Chat generative pre-trained transformer (GPT) is attracting attention. The generative AI as the recent main stream uses a learned model, referred to as the Large Language Models (LLM), and is characterized in that a text or an image is generated based on an instruction using a natural language text. As the large language model, a multimodal model, such as GPT-4.0, has also appeared which can handle not only a natural language text as an input, but also image data and voice data as an input.

The large language model learns a huge amount of data to construct a database, which requires a large capacity of storage, and hence it is general that services are built on a large-scale server.

Further, the large language model comes to be more widely used not only for generating texts and images, but also for proofreading input texts. In the case of such use form, a user is required to prepare data, which is desired to be proofread, in a terminal at hand in advance, and transmit the data from the terminal to a server in which a large language model has been constructed. In a case where data desired to be proofread is acquired from a paper medium as image data, the user is required to take time and effort for scanning an original using a scanner to form the data and taking the data into the terminal, such as a personal computer, and transmitting the data from the terminal to the server.

On the other hand, Japanese Laid-Open Patent Publication (Kokai) No. 2017-11490 discloses a technique of transmitting scanned data to a server and detecting whether proofread information exists in the image data.

However, the technique disclosed in Japanese Laid-Open Patent Publication (Kokai) No. 2017-11490 has a problem that it is necessary to manually perform proofreading of an original before scanning, and hence the burden of proofreading on a user is only partially reduced.

### SUMMARY OF THE INVENTION

The present invention provides a mechanism that makes it possible to obtain a high-accuracy result of proofreading of an original of a paper medium with a simple operation.

In a first aspect of the present invention, there is provided an image processing apparatus that communicably connects to a proofreading server that performs inference using a learned model, including an acquisition unit configured to acquire image data read from an original, a generation unit configured to generate a prompt for causing the proofreading server to proofread the acquired image data, a proofreading result request unit configured to transmit the acquired image data and the generated prompt to the proofreading server, and cause the proofreading server to perform proofreading on the acquired image data based on the generated prompt using the learned model, and output a result of the proofreading, and an output unit configured to output a proofreading result output from the proofreading server to an output destination.

In a second aspect of the present invention, there is provided a method of controlling an image processing apparatus that communicably connects to a proofreading server that performs inference using a learned model, including acquiring image data read from an original, generating a prompt for causing the proofreading server to proofread the acquired image data, transmitting the acquired image data and the generated prompt to the proofreading server, and causing the proofreading server to perform proofreading on the acquired image data based on the generated prompt using the learned model, and output a result of the proofreading, and outputting a proofreading result output from the proofreading server to an output destination.

According to the present invention, it is possible to obtain a high-accuracy result of proofreading of an original of a paper medium with a simple operation.

Further features of the present invention will become apparent from the following description of exemplary embodiments (with reference to the attached drawings).

### BRIEF DESCRIPTION OF THE DRAWINGS

FIG. 1 is a diagram showing a basic configuration of a system including an image processing apparatus according to the present embodiment.

FIG. 2 is a block diagram showing a basic hardware configuration of an inside of the image processing apparatus.

FIG. 3 is a block diagram showing a basic hardware configuration of an inside of a large language model server.

FIG. 4 is a flowchart of a proofreading scan process according to the present embodiment.

FIG. 5 is a diagram showing a main menu screen displayed on a display appearing in FIG. 2.

FIG. 6 is a diagram showing a proofreading scan screen displayed on the display.

FIG. 7 is a flowchart of a preview screen display control process.

FIG. 8 is a diagram showing a proofreading scan screen including a preview screen, which is displayed in a step in FIG. 4.

FIG. 9 is a diagram showing an example of image data which is output as a proofreading result from the large language model server and in which proofreading items are superimposed on image data obtained by scanning an original on which a notification has been printed.

FIG. 10 is a diagram showing text data of a list of texts converted from the proofreading result shown in FIG. 9, which is output from the large language server.

FIG. 11 is a diagram showing an example of image data which is output as a proofreading result from the large language model server and in which a proofreading item is superimposed on image data obtained by scanning an original on which a form has been printed.

FIG. 12 is a flowchart of a proofreading scan data transmission execution process performed by a central processing unit (CPU) when a proofreading scan data transmission screen is displayed.

FIG. 13 is a diagram showing a proofreading scan data transmission screen displayed in a step S714 in FIG. 7.

FIG. 14 is a diagram showing an AI destination setting screen.

FIG. 15 is a diagram showing a prompt generation table used in a step S408 in FIG. 4.

### DESCRIPTION OF THE EMBODIMENTS

The present invention will now be described in detail below with reference to the accompanying drawings showing embodiments thereof. Note that the present invention is not limited to the embodiments described below, and not all combinations of features described in the embodiments are absolutely essential to solution according to the invention.

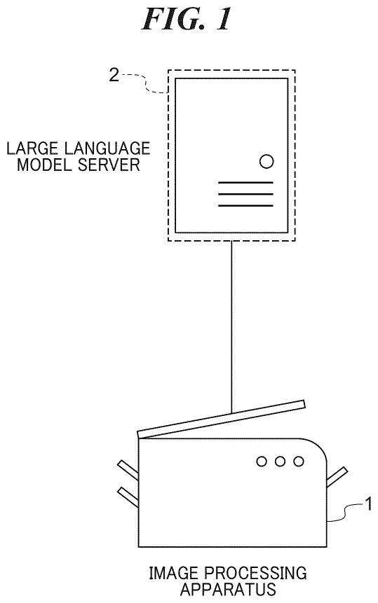

FIG. 1 is a diagram showing a basic configuration of a system including an image processing apparatus according to the present embodiment.

Referring to FIG. 1, one system is formed by communicably connecting the image processing apparatus, denoted by reference numeral 1, and a large language model server 2, via a network.

The large language model server 2 generates output data therein based on an instruction and data input, which are received from the image processing apparatus 1, via the network, and transmits the output data to the image processing apparatus 1 via the network as a response.

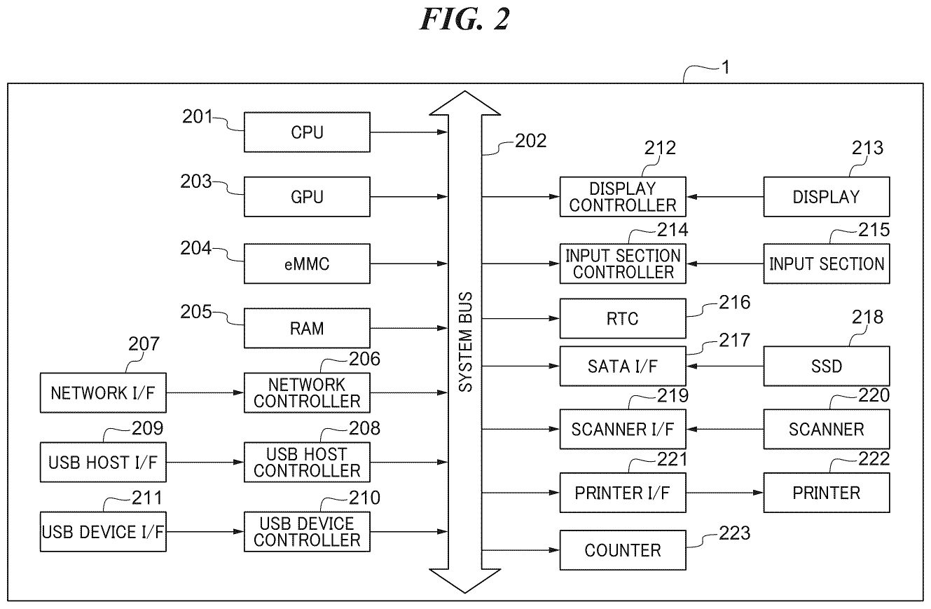

FIG. 2 is a block diagram showing a basic hardware configuration of an inside of the image processing apparatus 1.

The image processing apparatus 1 includes a CPU 201, a graphical processing unit (GPU) 203, an embedded MultiMediaCard (eMMC) 204, a random access memory (RAM) 205, a network controller 206, a universal system bus (USB) host controller 208, and a USB device controller 210, as the devices connected to a system bus 202. Further, the image processing apparatus 1 includes a display controller 212, an input section controller 214, a real-time clock (RTC) 216, a serial advanced technology attachment (SATA) interface (I/F) 217, a scanner I/F 219, a printer I/F 221, and a counter 223, as the devices connected to the system bus 202. These devices can communicate with each other via the system bus 202.

The CPU 201 is a central processing unit that operates software for operating the image processing apparatus 1.

The GPU 203 is a graphics processing unit that performs image processing.

The eMMC 204 stores the software (programs) of the image processing apparatus 1, a database necessary for the operation of the image processing apparatus 1, and a temporary storage file.

The RAM 205 is a random access memory which is used for loading a program of the image processing apparatus 1 and is used as an area for storing variables when the program operates and data transferred from each unit by direct memory access (DMA).

The network controller 206 controls a network I/F 207 for performing communication between the image processing apparatus 1 and other devices on the network. The CPU 201 transmits image data and prompts, described hereinafter, to the large language model server 2 via the network controller 206 and the network I/F 207. Further, the CPU 201 receives a proofreading result, which is inferred by a learned model, described hereinafter, based on the image data and the prompts, and is transmitted from the large language model server 2, via the network controller 206 and the network I/F 207.

The USB host controller 208 controls a USB host I/F 209 for connecting to a USB device to perform communication when the image processing apparatus 1 functions as a USB host.

The USB device controller 210 controls a USB device I/F 211 for connecting to a USB host to perform communication when the image processing apparatus 1 functions as a USB device.

The display controller 212 performs display control of a display 213 that displays an operating status of the image processing apparatus 1 so as to enable a user to confirm the operating status.

The input section controller 214 controls an input section 215 that receives an instruction to the image processing apparatus 1 from a user. The input section 215 is specifically an input system including a keyboard, a mouse, a numeric key, a cursor key, a touch panel, and an operation section keyboard. In a case where the input section 215 is a touch panel, the input section 215 is physically mounted on a surface of the display 213.

The RTC 216 is a real-time clock having a clock function, an alarm function, a timer function, and so forth.

The serial advanced technology attachment (SATA) I/F 217 is an interface for connecting a solid state driver (SSD) 218 to the image processing apparatus 1. The SSD 218 stores a file having a large size, temporary data of an application, and so forth.

The scanner I/F 219 is an interface for connecting a scanner 220 that reads an image from an original to the image processing apparatus 1. The CPU 201 acquires image data of an image read from an original by using the scanner 220 from the scanner I/F 219 (acquisition unit).

The printer I/F 221 is an interface for connecting a printer 222 for printing image data to the image processing apparatus 1.

The counter 223 records the number of copies of each print job.

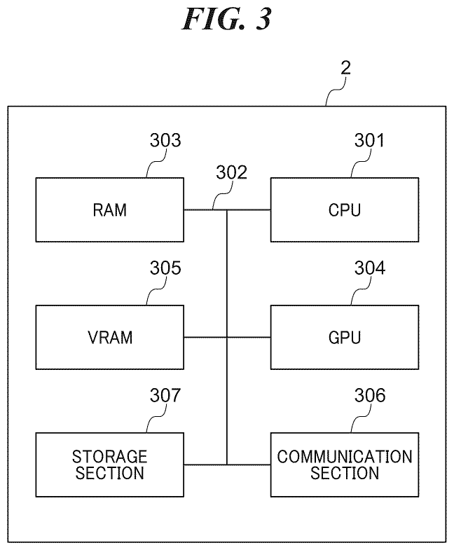

FIG. 3 is a block diagram showing a basic hardware configuration of an inside of the large language model server 2.

Referring to FIG. 3, the large language model server 2 includes a CPU 301, a RAM 303, a GPU 304, a video random access memory (VRAM) 305, a communication section 306, and a storage section 307, as the devices connected to a system bus 302. These devices can communicate with each other via the system bus 302.

The CPU 301 operates software for operating the large language model server 2.

The RAM 303 is used for loading a program executed by the CPU 301, and the storage section 307 is used as an area for storing programs and data.

The communication section 306 can perform communication with external apparatuses including the image processing apparatus 1 via the network and inputs and outputs data from and to the external apparatuses.

In the storage section 307, a model learned by machine learning (learned model) is stored. As the learned model, for example, a model using a neural network architecture, referred to as the transformer, is used.

The GPU 304 is used for a process for generating output data by performing inference using the learned model stored in the storage section 307.

The VRAM 305 is used as a location where data to be used is loaded when the GPU 304 performs processing. When the large language model server 2 (proofreading server) receives image data and instructions, referred to as prompts, which are input from an external apparatus, via the communication section 306, the CPU 301 uses the GPU 304 to perform inference using the learned model stored in the storage section 307. Data output as a result of the inference (e.g. image data representing a proofreading result, described hereinafter) is transmitted to the external apparatus via the communication section 306 as a response. The large language model server 2 can receive prompts using a natural language, and this enables the external apparatus to provide flexible instructions and retrieve a variety of outputs from the learned model. Note that here, the inference is performed by using the GPU 304, by way of example, but the CPU 301 can perform the inference instead.

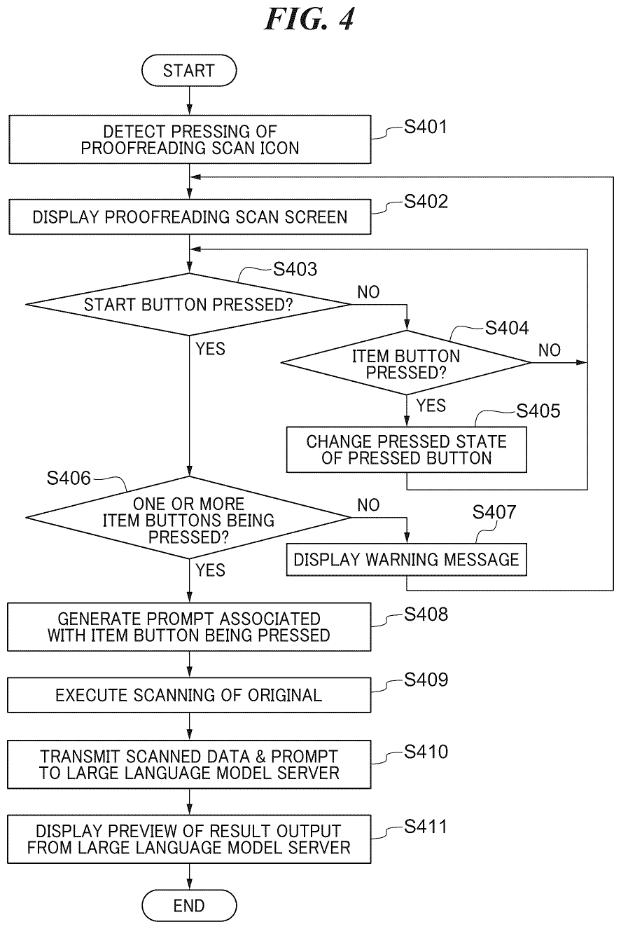

FIG. 4 is a flowchart of a proofreading scan process according to the present embodiment. The present process is executed by the CPU 201 that reads out a program stored in the eMMC 204 and loads the read program into the RAM 205.

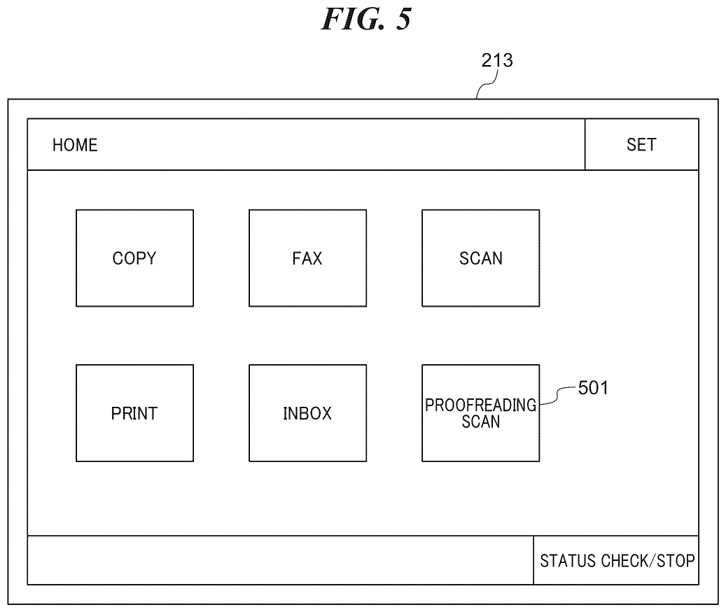

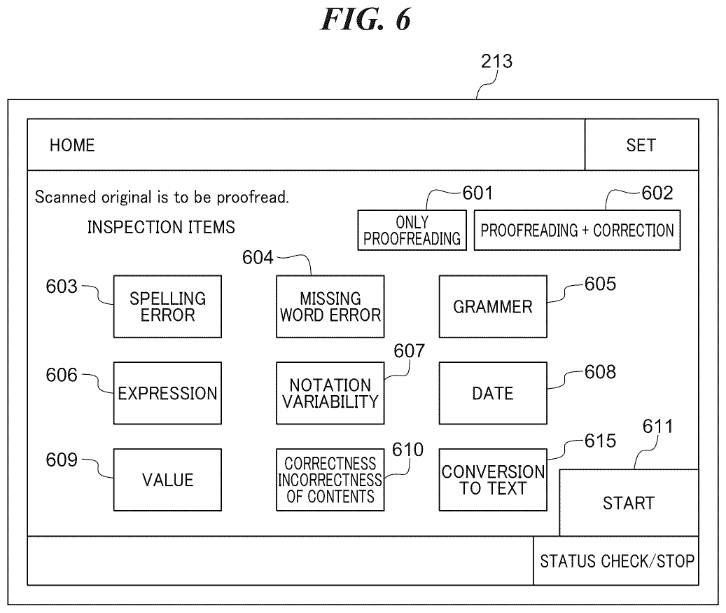

The present process will be described below using screens shown in FIGS. 5 and 6 and displayed on the display 213. Note that icon arrangements and words on the screens shown in FIGS. 5 and 6 are indicated by way of example and are not intended to limit the configuration of the present invention.

The present process is started from a state in which a main menu screen shown in FIG. 5 is displayed on the display 213.

First, in a step S401, when a proofreading scan icon 501 on the main menu screen (see FIG. 5) is detected to be pressed, the CPU 201 proceeds to a step S402 and displays a proofreading scan screen (first display unit) shown in FIG. 6 on the display 213.

As shown in FIG. 6, on the proofreading scan screen, buttons 601 to 610 and 615 for receiving a user's instruction of proofreading contents, and a start button 611 are displayed, in a state selectable by a user.

Referring again to FIG. 4, if at least one of the buttons 601 to 610 and 615 is detected to be pressed (YES in S404) before the start button 611 is pressed (NO in S403), the CPU 201 proceeds to a step S405, whereas if not (NO in S404), the CPU 201 returns to the step S403.

In the step S405, the CPU 201 changes the pressed state of the button detected to be pressed, from “non-pressed” to “being pressed”. Here, the “being pressed” state refers to a state in which the button in question is being selected by the user, and the “non-pressed” state refers to a state in which the button in question is not being selected by the user. The pressed state of each of the buttons 601 to 610 and 615 is stored in the RAM 205. Note that when a button, the pressed state of which has been set to “being pressed”, is detected to be pressed again, the CPU 201 changes the pressed state of the button detected to be pressed again to “non-pressed”. Further, the “only proofreading” button 601 and the “proofreading+correction” button 602 are in an exclusive relation, and the pressed state of only one of these buttons can be changed to “being pressed”.

If the start button 611 is detected to be pressed (YES in S403), the CPU 201 proceeds to a step S406 and determines whether or not one or more buttons of the buttons 603 to 610 (inspection items) are in the “being pressed” state. If no button is in the “being pressed” state (NO in S406), the CPU 201 displays a warning message (step S407), then returns to the step S402, and displays the proofreading scan screen again. On the other hand, if the pressed state of at least one of the buttons is “being pressed” (YES in S406), the CPU 201 (generation unit) generates a prompt each associated with a button in the “being pressed” state (step S408). Each prompt generated in this step is e.g. an instruction text using a natural language, and the CPU 201 generates a text for instructing the large language model server 2 to perform proofreading of image data.

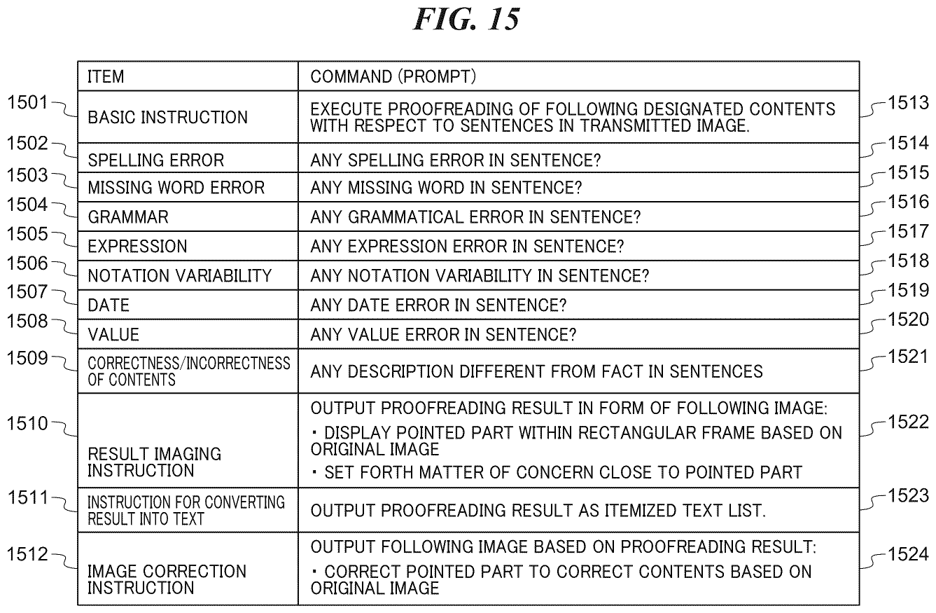

In the present embodiment, the CPU 201 generates prompts in the step S408 with reference to a prompt generation table (see FIG. 15) stored in the eMMC 204 in advance.

As shown in FIG. 15, the prompt generation table includes items 1501 to 1512 and prompts 1513 to 1524 each in a natural language, which are associated with the items 1501 to 1512, respectively.

The items 1502 to 1509 are associated with the buttons 603 to 610, respectively, the item 1510 is associated with the buttons 601 and 602, the item 1511 is associated with the button 615, and the item 1512 is associated with the button 602.

When generating prompts in the step S408, the CPU 201, first, reads a prompt 1513 corresponding to the item 1501 of “basic instruction” into the RAM 205.

Next, in a case where any of the buttons 603 to 610 is/are in the pressed state of “being pressed”, the CPU 201 loads a prompt or prompts associated with the button(s) into the RAM 205.

Further, in a case where the pressed state of one of the “only proofreading” button 601 and the “proofreading+correction” button 602 is “being pressed”, the CPU 201 reads a prompt 1522 of “instruction for imaging a result” into the RAM 205. Further, in a case where the pressed state of the “proofreading+correction” button 602 (proofreading & correction instruction item) is “being pressed”, the CPU 201 reads a prompt 1524 (correction instruction prompt) of “instruction for correcting an image” into the RAM 205. Further, in a case where the pressed state of the “conversion to text” button 615 (instruction item for conversion to a text) is “being pressed”, the CPU 201 reads a prompt 1523 (conversion-to-text instruction prompt) of “instruction for converting a result into a text” into the RAM 205.

Finally, the CPU 201 generates one prompt by consolidating all prompts loaded into the RAM 205.

Referring again to FIG. 4, after generating the prompt in the step S408, the CPU 201 executes scanning of the original (step S409). The CPU 201 provides a scan instruction to the scanner 220 via the scanner I/F 210, whereby scanning of the original is executed. Then, the CPU 201 (proofreading result request unit) stores the scanned image data in the eMMC 204 or the RAM 205.

Next, the CPU 201 (proofreading result request unit) transmits the image data and the prompt to the large language model server 2 via the network controller 206 and the network I/F 207 (step S410). The data can be transmitted in a form using the Web application programming interface (API) using e.g. hypertext transfer protocol (HTTP) communication.

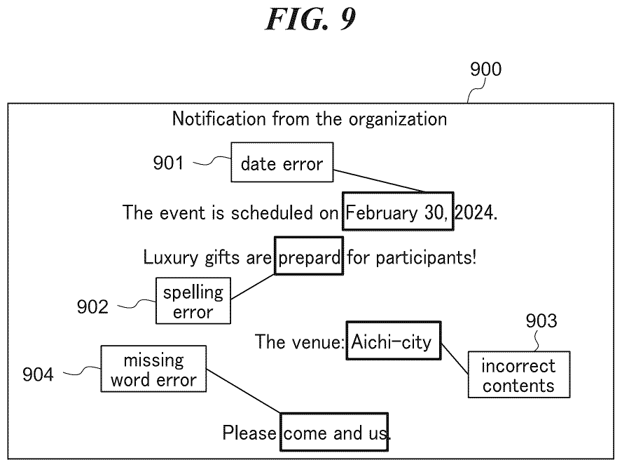

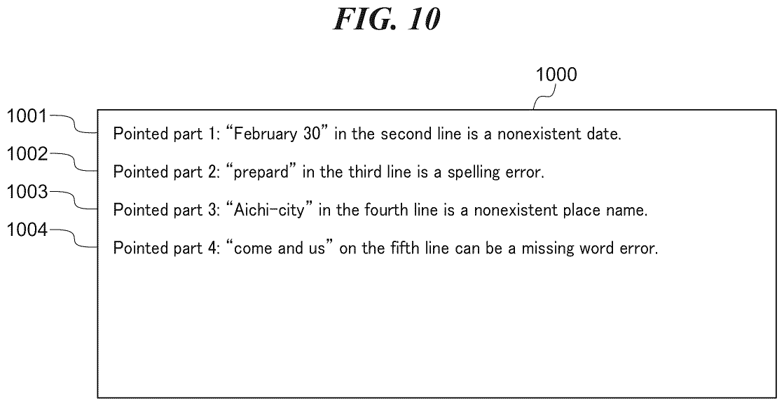

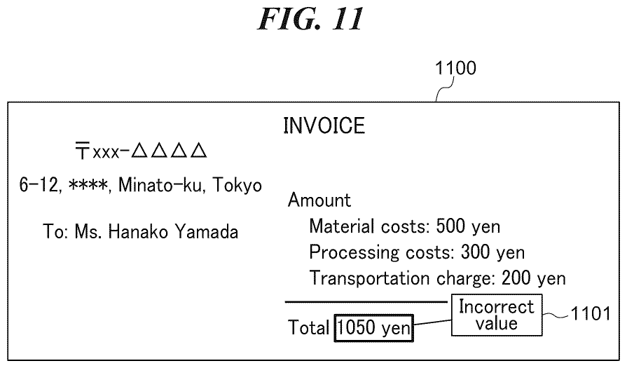

Upon receipt of the image data and the prompt from the image processing apparatus 1 in the step S410, the CPU 301 of the large language model server 2 performs proofreading of the image data based on the prompt, and outputs a result of the proofreading to the image processing apparatus 1. This proofreading result can be such image data as shown in FIGS. 9 and 11 or such text data indicating a list of texts converted from the proofreading results as shown in FIG. 10. The CPU 301 transmits the output proofreading result from the communication section 306 to the image processing apparatus 1, and the CPU 201 stores the received data in the eMMC 204 or the RAM 205. In doing this, in a case where the pressed state of the “only proofreading” button 601 is “being pressed”, the CPU 201 receives only the image data which has been proofread. On the other hand, in a case where the pressed state of the “proofreading+correction” button 602 is “being pressed”, the CPU 201 receives corrected image data on which an error point has been corrected based on the proofreading result together with the image data which has been proofread. In a case where the corrected image data is received together with the image data which has been proofread, the CPU 201 adds the corrected image data to the image data which has been proofread as another page. Further, in a case where the pressed state of the “conversion to text” button 615 is “being pressed”, the CPU 201 receives text data generated by converting the proofreading result into a text.

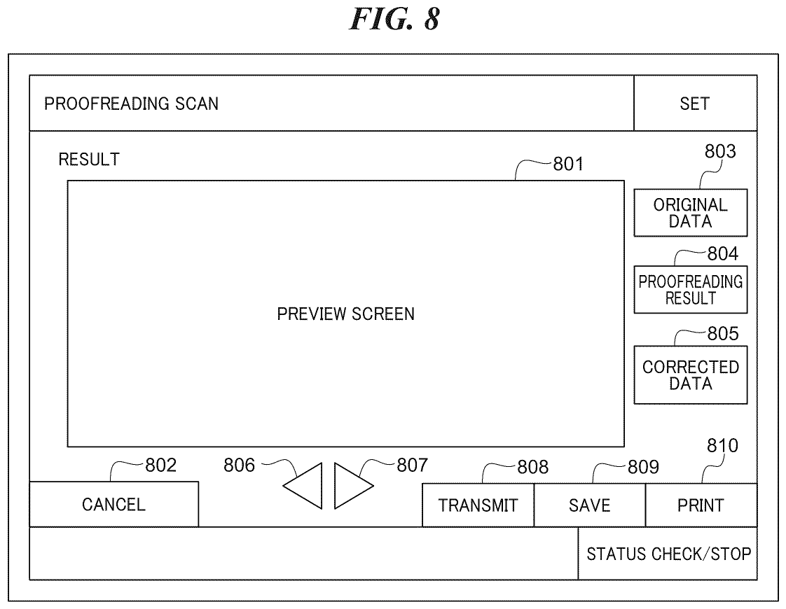

In a step S411, the CPU 201 (output unit) stores the received proofreading result in the eMMC 204 or the RAM 205 (output destination) and displays the received proofreading result on a preview screen 801 (see FIG. 8) on the display 213 (output destination), followed by terminating the present process. In the step S411, the image data of the proofreading result, shown in FIG. 9 or 11 by way of example, is displayed on the preview screen 801.

FIG. 8 is a diagram showing the proofreading scan screen including the preview screen 801, which is displayed in the step S411 in FIG. 4.

The proofreading scan screen includes the preview screen 801, a cancel button 802, an original data button 803, a proofreading result button 804, a corrected data button 805, and page switching buttons 806 and 807. Further, the proofreading scan screen includes a transmission button 808, a save button 809, and a print button 810. These buttons are each formed by an icon selectable by the user.

Next, a flow of a process for controlling the display of the preview screen 801 displayed in the step S411 will be described.

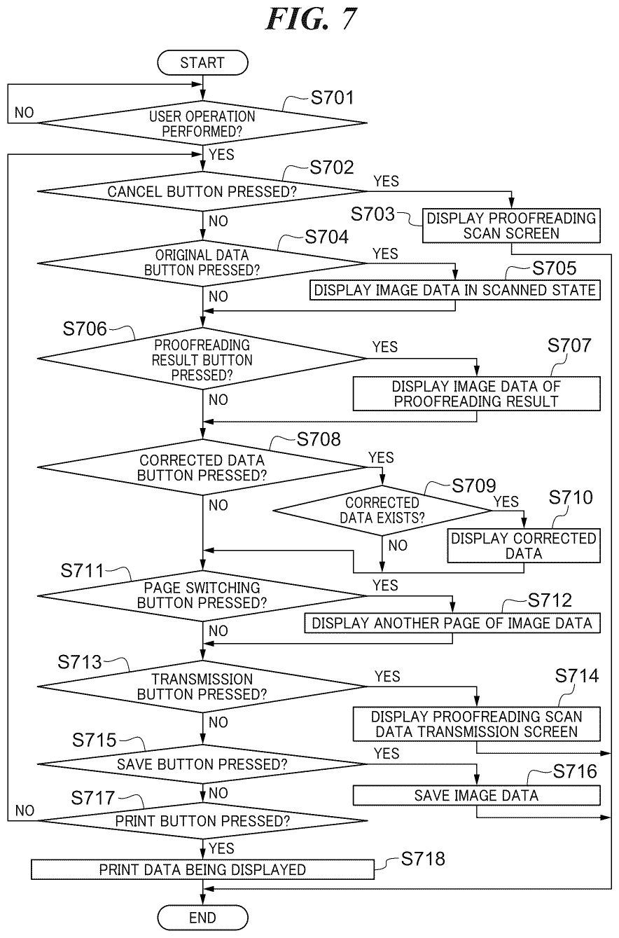

FIG. 7 is a flowchart of a preview screen display control process executed according to a user's operation after displaying the preview screen in the step S411. The present process is executed by the CPU 201 that reads out a program stored in the eMMC 204 and loads the read program into the RAM 205.

The present process will be described below with reference to the proofreading results shown in FIGS. 9 to 11, each of which is received from the large language model server 2 and is displayed on the preview screen 801 by the CPU 201. Note that image data shown in each of FIGS. 9 to 11 is only example and is not intended to limit the scope of the present invention.

First, in a step S701, the CPU 201 detects whether or not a user's operation has been performed on the proofreading scan screen. If a user's operation has been performed (YES in S701), the CPU 201 proceeds to a step S702. On the other hand, if no user's operation has been performed (NO in S701), the CPU 201 waits until a user's operation is performed.

If the cancel button 802 is detected to be pressed (YES in S702), the CPU 201 changes the preview screen 801 of the proofreading scan screen, shown in FIG. 8, to a blank space display (step S703), followed by terminating the present process. On the other hand, if the cancel button 802 has not been pressed (NO in S702), the CPU 201 proceeds to a step S704 and detects whether or not the original data button 803 has been pressed.

If the original data button 803 is detected to be pressed (YES in S704), the CPU 201 displays the data of the original, which has been scanned in the step S409 but has not been proofread, on the preview screen 801 (step S705), and then proceeds to a step S706. On the other hand, if the original data button 803 has not been pressed (NO in S704), the CPU 201 directly proceeds to the step S706 and detects whether or not the proofreading result button 804 has been pressed.

If the proofreading result button 804 is detected to be pressed (YES in S706), the CPU 201 displays the proofreading result output from the large language model server 2 on the preview screen 801 (step S707), and then proceeds to a step S708. On the other hand, if the proofreading result button 804 has not been pressed (NO in S706), the CPU 201 directly proceeds to the step S708 and detects whether or not the corrected data button 805 has been pressed.

FIG. 9 is a diagram showing an example of image data 900 output from the large language model server 2 as a proofreading result, in which proofreading items are superimposed on image data obtained by scanning an original on which a notification has been printed. The image data 900 is displayed on the preview screen 801 by the CPU 201 when the proofreading result button 804 (see FIG. 8) is pressed, and proofreading items are associated with respective pointed parts each surrounded by a frame, as illustrated by proofreading items 901 to 904. Note that the pointed part can be indicated by using a method other than the method of using a frame surrounding a pointed part as shown in FIG. 9 insofar as the pointed part is highlighted in the image data 900. For example, the pointed part can be displayed by bold characters or shown in a flashing display.

FIG. 11 is a diagram showing an example of image data 1100 output from the large language model server 2 as a proofreading result, in which the proofreading item is superimposed on image data obtained by scanning an original on which a form has been printed. Similar to the image data 900 shown in FIG. 9, the image data 1100 shown in FIG. 11 is displayed on the preview screen 801 when the proofreading result button 804 (see FIG. 8) is pressed, and a proofreading item is associated with a pointed part (error in value in this example) surrounded by a frame, as illustrated by a proofreading item 1101.

Referring again to FIG. 7, if the corrected data button 805 is detected to be pressed (YES in S708), the CPU 201 detects whether or not corrected image data exists in the eMMC 204 or the RAM 205 (step S709). If the corrected image data exists (YES in S709), the CPU 201 displays the corrected image data (step S710) and proceeds to a step S711. On the other hand, if the corrected data button 805 has not been pressed or the corrected data does not exist (NO in S708 or NO in S709), the CPU 201 directly proceeds to the step S711.

In the step S711, the CPU 201 detects whether or not one of the page switching buttons 806 and 807 has been pressed.

The CPU 201 detects whether or not one of the page switching buttons 806 and 807 has been pressed (a user's instruction has been provided) (step S711). If one of the page switching buttons 806 and 807 has been pressed (YES in S711), the CPU 201 changes the image data being displayed on the preview screen 801 to display another page (such as the corrected image data or image data 1000 (see FIG. 10)) of the image data (step S712). On the other hand, if none of the page switching buttons 806 and 807 has been pressed (NO in S711), the CPU 201 proceeds to a step 713 and detects whether or not the transmission button 808 has been pressed.

FIG. 10 is a diagram showing the image data 1000 which is output from the large language model server 2 and illustrates a list of texts converted from the proofreading result shown in FIG. 9. When the proofreading result shown in FIG. 9 is received from the large language model server 2, the CPU 201 (conversion unit) converts the proofreading result to the image data 1000. Then, the CPU 201 adds the image data 1000 to the proofreading result (image data 900) output from the large language model server 2 as another page. Further, if one of the page switching buttons 806 and 807 (see FIG. 8) is pressed when the image data 900 shown in FIG. 9 is being displayed on the preview screen 801, the CPU 201 changes the preview screen 801 to the image data 1000 shown in FIG. 10. In the image data 1000, the pointed items each formed by a pointed part and a pointed content in the image data 900 are displayed in a list, as illustrated by pointed items 1001 to 1004.

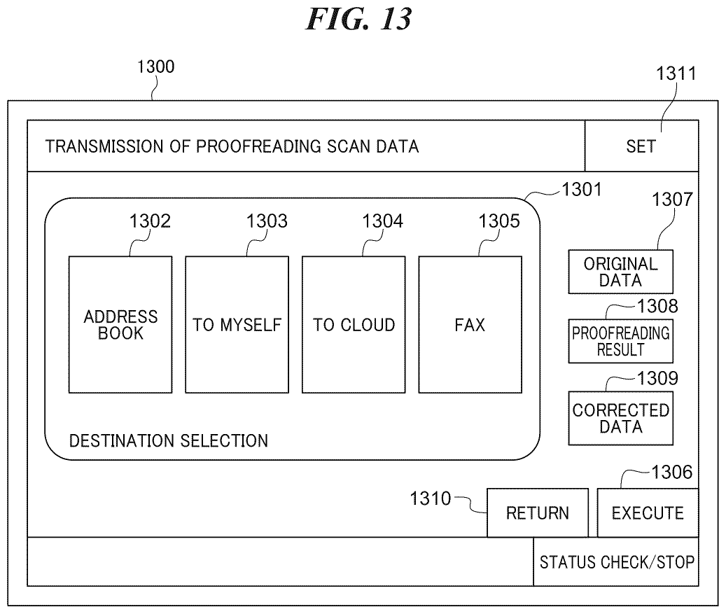

Referring again to FIG. 7, if the transmission button 808 is detected to be pressed (YES in S713), the CPU 201 proceeds to a step S714. In the step S714, the CPU 201 displays a proofreading scan data transmission screen 1300 (see FIG. 13) for displaying a plurality of destinations which can each be set as the transmission destination in a state selectable by a user, followed by terminating the present process. The user can transmit the original data and the image data 900 (the corrected data can also be transmitted, if acquired) to a desired destination by operating the proofreading scan data transmission screen 1300. On the other hand, if the transmission button 808 has not been pressed (NO in S713), the CPU 201 proceeds to a step S715 and detects whether or not the save button 809 has been pressed. Note that the proofreading scan data is one of data of an original which has been scanned but not proofread, image data output from the large language model server 2 as a proofreading result, and image data on which an error point has been corrected based on the proofreading result output from the large language model server 2.

If it the save button 809 is detected to be pressed (YES in S715), the CPU 201 stores the scanned image data and the image data output from the large language model server 2 in a predetermined area of the eMMC 204 (step S716), followed by terminating the present process. On the other hand, if the save button 809 has not been pressed (NO in S715), the CPU 201 proceeds to a step S717 and detects whether or not the print button 810 has been pressed.

If the print button 810 is detected to be pressed (YES in S717), the CPU 201 proceeds to a step S718. On the other hand, if the print button 810 has not been pressed (NO in S717), the CPU 201 returns to the step S702.

In the step S718, the CPU 201 transmits the image data to the printer 222 via the printer I/F 221 to execute printing, followed by terminating the present process. Note that the image data to be printed can be designated by the user.

Next, a flow of a proofreading scan data transmission execution process executed when the proofreading scan data transmission screen 1300 is displayed in the step S714 will be described.

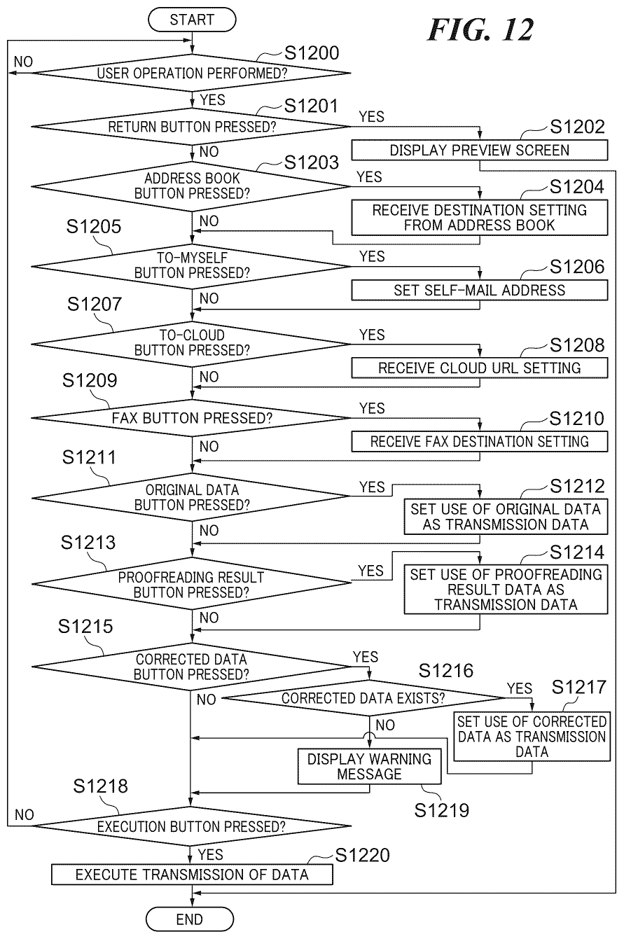

FIG. 12 is the flowchart of the proofreading scan data transmission execution process performed by the CPU 201 when the proofreading scan data transmission screen 1300 is being displayed. The present process is executed by the CPU 201 that reads out a program stored in the eMMC 204 and loads the read program into the RAM 205.

First, in a step S1200, the CPU 201 detects whether or not a user's operation has been performed on the proofreading scan data transmission screen 1300. If a user's operation has been performed (YES in S1200), the CPU 201 proceeds to a step S1201 and detects whether or not a return button 1310 has been pressed. On the other hand, if no user's operation has been performed (NO in S1200), the CPU 201 waits until a user's operation is performed.

If the return button 1310 is detected to be pressed (YES in S1201), the CPU 201 displays the preview screen 801 (step S1202), followed by terminating the present process. On the other hand, if the return button 1310 has not been pressed (NO in S1201), the CPU 201 proceeds to a step S1203 and detects whether or not an address book button 1302 has been pressed.

If the address book button 1302 is detected to be pressed (YES in S1203), the CPU 201 receives an address set from the address book to set the transmission destination to the received address (step S1204), and the CPU 201 proceeds to a step S1205. On the other hand, if the address book button 1302 has not been pressed (NO in S1203), the CPU 201 directly proceeds to the step S1205 and detects whether or not a to-myself button 1303 has been pressed.

If it the to-myself button 1303 is detected to be pressed (YES in S1205), the CPU 201 sets a mail address of the user who is operating the image processing apparatus 1 (step S1206) and proceeds to a step S1207. On the other hand, if the to-myself button 1303 has not been pressed (NO in S1205), the CPU 201 directly proceeds to the step S1207 and detects whether or not a to-cloud button 1304 has been pressed.

If the to-cloud button 1304 is detected to be pressed (YES in S1207), the CPU 201 receives the URL of the cloud and sets the destination to the received URL (step S1208), whereafter the CPU 201 proceeds to a step S1209. On the other hand, if the to-cloud button 1304 has not been pressed (NO in S1207), the CPU 201 directly proceeds to the step S1209 and detects whether or not a fax button 1305 has been pressed.

If the fax button 1305 is detected to be pressed (YES in S1209), the CPU 201 receives the destination of the fax and sets the transmission destination to the received destination (step S1210), whereafter the CPU 201 proceeds to a step S1211. On the other hand, if the fax button 1305 has not been pressed (NO in S1209), the CPU 201 directly proceeds to the step S1211 and detects whether or not an original data button 1307 has been pressed.

If the original data button 1307 is detected to be pressed (YES in S1211), the CPU 201 performs setting so as to use the image data (original data) which has not been changed after being scanned, as the transmission data (step S1212), and then proceeds to a step S1213. On the other hand, if the original data button 1307 has not been pressed (NO in S1211), the CPU 201 directly proceeds to the step S1213 and detects whether or not a proofreading result button 1308 has been pressed.

If the proofreading result button 1308 is detected to be pressed (YES in S1213), the CPU 201 performs setting to use the proofreading result data (the image data shown in FIG. 9 or 10 in this example) as the transmission data (step S1214) and proceeds to a step S1215. On the other hand, if the proofreading result button 1308 has not been pressed (NO in S1213), the CPU 201 directly proceeds to the step S1215 and detects whether or not a corrected data button 1309 has been pressed. If the corrected data button 1309 has not been pressed (NO in S1215), the CPU 201 proceeds to a step S1218 and detects whether or not an execution button 1306 has been pressed.

On the other hand, if the corrected data button 1309 is detected to be pressed (YES in S1215), the CPU 201 detects whether or not the corrected data exists (step S1216). If the corrected data does not exist (NO in S1216), the CPU 201 displays a warning message (step S1219) and then proceeds to the step S1218. On the other hand, if the corrected data exists (YES in S1216), the CPU 201 performs setting so as to use the corrected data as the transmission data (step S1217) and then proceeds to the step S1218.

If the execution button 1306 is detected to be pressed (YES in S1218), the CPU 201 executes transmission of the transmission data set as the transmission data to the transmission destination set as the destination (step S1220), followed by terminating the present process. On the other hand, if the execution button 1306 has not been pressed (NO in S1218), the CPU 201 returns to the step S1200.

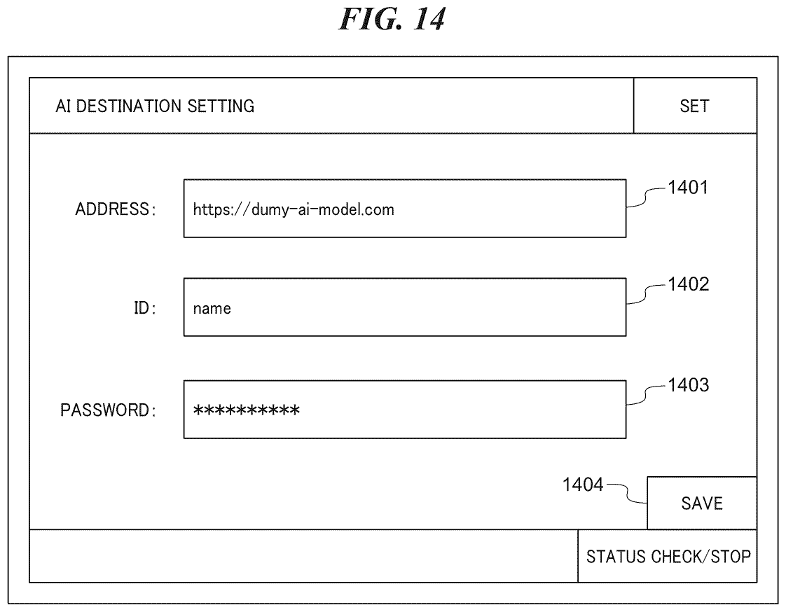

FIG. 14 is a diagram showing an AI destination setting screen.

Here, the AI destination setting screen (destination setting user interface (UI)) is a screen on which a setting of access to the large language model server 2 used for proofreading can be set. This screen is displayed in a case where an AI destination setting menu is selected on a menu screen (not shown) displayed when a set button 1311 on the proofreading scan data transmission screen 1300 (see FIG. 13) is pressed.

Referring to FIG. 14, the AI destination setting screen includes an address setting section 1401, an ID setting section 1402, a password setting section 1403, and a save button 1404.

In the address setting section 1401, an internet protocol (IP) address, a URL, or the like is set. In the ID setting section 1402 and the password setting section 1403, an ID and a password, which are required for authentication, are set, respectively, when a service of the large language model server 2 is used. When accessing the large language model server 2 set by the address setting section 1401, the CPU 201 performs authentication by using the information input to the ID setting section 1402 and the password setting section 1403.

As described above, in the present embodiment, the proofreading scan screen is displayed in the step S402 in FIG. 4, the setting of the inspection item is received in the steps S404 and S405, and the scanned image is transmitted to the large language model server 2 to execute proofreading in the steps $408 to S411. With this, the user can obtain a high-accuracy result of proofreading with a simple operation.

Further, by setting the address of the large language model server 2, and the ID and the password for authentication, which are required for accessing the large language model server 2, in advance, it is possible to smoothly perform the processing in the step S410.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-035859 filed Mar. 8, 2024, which is hereby incorporated by reference herein in its entirety.

What is claimed is:

1. An image processing apparatus that communicably connects to a proofreading server that performs inference using a learned model, comprising:
an acquisition unit configured to acquire image data read from an original;
a generation unit configured to generate a prompt for causing the proofreading server to proofread the acquired image data;
a proofreading result request unit configured to transmit the acquired image data and the generated prompt to the proofreading server, and cause the proofreading server to perform proofreading on the acquired image data based on the generated prompt using the learned model, and output a result of the proofreading; and
an output unit configured to output a proofreading result output from the proofreading server to an output destination.

2. The image processing apparatus according to claim 1, wherein the proofreading server is a large language model server.

3. The image processing apparatus according to claim 1, wherein the output unit displays image data representing the proofreading result on a preview screen.

4. The image processing apparatus according to claim 1, wherein the output unit transmits image data representing the proofreading result to a predetermined destination.

5. The image processing apparatus according to claim 1, wherein the generated prompt is a text using a natural language.

6. The image processing apparatus according to claim 1, further comprising a first display unit configured to display a plurality of inspection items for generating the prompt in a state selectable by a user, and
wherein the generation unit generates the prompt according to an inspection item or inspection items selected by a user from the plurality of inspection items.

7. The image processing apparatus according to claim 6, wherein the first display unit further displays a proofreading & correction instruction item for instructing proofreading and correction in a state selectable by a user, and
wherein in a case where the proofreading & correction instruction item is selected by a user, the generation unit further generates a correction instruction prompt for instructing correction of the acquired image data, and the proofreading result request unit further transmits the correction instruction prompt to the proofreading server and causes the proofreading server to generate image data on which an error part has been corrected based on the proofreading result, and output the corrected image data.

8. The image processing apparatus according to claim 7, wherein the output unit displays one of the corrected image data and the image data representing the proofreading result after switching therebetween, on a preview screen, according to a user's instruction.

9. The image processing apparatus according to claim 6, wherein the first display unit further displays a text conversion instruction item for instructing acquisition of a list of texts converted from the proofreading result in a state selectable by a user, and
wherein in a case where the text conversion instruction item is selected by a user, the generation unit further generates a conversion-to-text instruction prompt for instructing acquisition of a list of texts converted from the proofreading result, and the proofreading result request unit further transmits the conversion-to-text instruction prompt to the proofreading server and causes the proofreading server to generate a list of texts converted from the proofreading result and output the list of the texts.

10. The image processing apparatus according to claim 9, further comprising a conversion unit configured to convert the list of the texts to image data, and
wherein the output unit displays one of the converted image data and the image data representing the proofreading result after switching therebetween, on a preview screen, according to a user's instruction.

11. The image processing apparatus according to claim 1, further comprising a destination setting UI for making a setting of access to the proofreading server, and
wherein the proofreading result request unit performs communication with the proofreading server by using the setting of access to the proofreading server, which has been made by the destination setting UI.

12. The image processing apparatus according to claim 3, wherein in the image data representing the proofreading result, a part pointed by the proofreading is highlighted and a proofreading item is displayed in a state associated with the pointed part.

13. The image processing apparatus according to claim 1, further comprising a second display unit configured to further display a plurality of destinations which can be set as the predetermined destination in a state selectable by a user.

14. A method of controlling an image processing apparatus that communicably connects to a proofreading server that performs inference using a learned model, comprising:
acquiring image data read from an original;
generating a prompt for causing the proofreading server to proofread the acquired image data;
transmitting the acquired image data and the generated prompt to the proofreading server, and causing the proofreading server to perform proofreading on the acquired image data based on the generated prompt using the learned model, and output a result of the proofreading; and
outputting a proofreading result output from the proofreading server to an output destination.

15. A non-transitory computer-readable storage medium storing a program for causing a computer to execute a method of controlling an image processing apparatus that communicably connects to a proofreading server that performs inference using a learned model,
wherein the method comprises:
acquiring image data read from an original;
generating a prompt for causing the proofreading server to proofread the acquired image data;
transmitting the acquired image data and the generated prompt to the proofreading server, and causing the proofreading server to perform proofreading on the acquired image data based on the generated prompt using the learned model, and output a result of the proofreading; and
outputting a proofreading result output from the proofreading server to an output destination.
